(19) United States
(12) Patent Application Publication
(10) Pub. No.: US 2007/0250327 A1
(43) Pub. Date: Oct. 25, 2007

(54) System and method for used vehicle valuation based on actual transaction data provided by industry participants

(76) Inventor: Shad Hedy, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/380,001

(22) Filed: Apr. 24, 2006

(51) Int. Cl. G06Q 10/00; G06Q 30/00

(52) U.S. Cl. 705/1

(57) ABSTRACT

A vehicle valuation system supplies accurate wholesale, retail, purchase, and reconditioning values of used automobiles based upon actual transaction data for selected geographical areas. The system validates transaction data to ensure data integrity. A transaction database is populated with validated transaction data received, either automatically from an application such as a dealer management system or upon dealer submission, via online communication. Valuation requests may be submitted from client computers, which may include remote computing devices such as personal computers, laptop computers and handheld computers based upon manual and/or scanned entries. In response to valuation requests, the system searches the transaction database for a matching record and returns the resulting wholesale, retail, purchase, and reconditioning values to a user either via a web application or mobile PDA application.

### FIELD OF THE INVENTION

This invention relates generally to valuation of used vehicles, and, more particularly, to a system and method of providing valuation data for used-vehicles based upon actual dealership information.

### BACKGROUND

In the used vehicle sales industry, Hearst Business Media Corporation's Black Book®, Kelley Blue Book Co., Inc.'s Blue Book® and the National Automobile Dealers Association's NADA® guide are primary sources of vehicle valuation and appraisal information for dealers. The Black Book® places a vehicle for a particular model year in one of four classes depending on its condition and then provides a wholesale price based on the prices dealers pay for cars at auctions that are not open to consumers. Like the Black Book®, the Kelley Blue Book classifies vehicles based on their condition and provides wholesale prices that generally correspond to those in the Black Book and are based upon auction and new and used-car dealership data. The values from NADA® are based upon information gathered from new- and used-car dealers, auto shows, trade periodicals, vehicle classifieds, magazines, newspapers, advisory boards, associations, and car clubs. Unlike Black Book® and Kelley Blue Book® prices, however, NADA prices do not vary with the vehicle's condition. The NADA® guide assumes that all vehicles are in excellent condition. Consequently, the prices in the NADA® guide are typically higher than prices in the Black Book® or Kelley Blue Book®. In each case, editors adjust accumulated purchase and sales data by mathematical factors and their own experience to provide their prices. Thus, the published prices are not actual sales data or even averages of actual sales data. Instead, they represent the publisher's own estimate for dealerships nationwide based primarily upon selected auctions, experience and subjective judgment.

As a result of scheduling of auctions and the analysis required for each vendor's publication, each publication is updated and published periodically with a considerable lag between actual auctions and corresponding adjustment of published prices. By way of example, the Black Book®, which is published the most frequently (i.e., weekly), accounts for results from dealer-only auctions from about a week or two prior to publication. The NADA® guide is published monthly and Blue Book® is published bi-monthly (i.e., 6 times per year), resulting in a more substantial delay between analysis and publication. While the publishers (and third parties) also offer computerized versions, the values are based upon information from the published guides.

Another shortcoming of conventional valuation guides is that they focus primarily on auction data which accounts for a small percentage of used cars purchased by dealerships. The guides generally overlook trade-in, dealer-to-dealer and consumer-to-dealer transactions, which constitute the majority of used car acquisitions by dealers.

Conventional valuation guides also do not provide different prices for different regions. One guide may be used more widely by dealers in the northwest while another guide may be used more widely by dealers in the southeast, because they are known to concentrate on auctions in their respective areas. However, none of the guides offers valuations for specified geographic regions (e.g., state, city, zip) based upon transactions within the specified region.

Conventional guides also fail to provide information useful for a dealership to fully evaluate the potential return on a used vehicle. For example, while conventional guides may supply retail price estimates, they do not provide a value of parts and labor typically required to restore a vehicle to a condition for resale. Likewise, conventional guides do not reveal how long a vehicle typically remains on a lot (nationwide or in a given geographic area) before it is resold. Furthermore, conventional guides do not provide market trend data that indicates what vehicles are selling well in a geographic area.

Additionally, while dealers regularly purchase vehicles at auctions to stock their lots, conventional guides are impractical to use effectively at such venues. During an auction, a dealer may have scant time to formulate a competitive bid. Using a printed guide, a dealer must refer to an index, locate a vehicle, then refer to the vehicle's page in the guide and determine a wholesale price, then adjust the price based upon mileage tables, and then add to the price to account for options. This conventional process is tedious and conducive to error. Even manual entry of vehicle make, model, year, options and condition into a portable computer is conducive to error and time consuming. Furthermore, both approaches fail to address certain important aspects of valuation such as whether a vehicle is in demand in the dealer's territory and how much work and parts are typically required to recondition such a vehicle for resale.

The invention is directed to fulfilling one or more of the needs and overcoming one or more of the problems as set forth above.

### SUMMARY OF THE INVENTION

To overcome one or more of the problems as set forth above, in one aspect of the invention, a vehicle valuation system is provided that supplies accurate wholesale, retail, purchase, and reconditioning values of used automobiles. In particular the system provides vehicle valuation data based upon actual transaction data for selected regions. The actual transaction data is gathered from industry participants, such as used auto dealerships, finance companies, insurance companies, banks, auctions, and warranty companies. Actual data, rather than manipulated valuation estimates as provided in published guides, is used. The system validates the data to ensure integrity. The valuation data includes wholesale pricing data, reconditioning data, days in inventory and retail pricing data, all of which is determined from actual transaction data and all of which is associated with geographical regions. The system is adapted to receive transaction data, either automatically from an application such as a dealer management system or upon dealer submission, via online communication. The received data populates a transaction database, which is used for determining valuation data for a user-specified vehicle and geographic area. The system is adapted to receive and process valuation requests from client computers, which may include remote computing devices such as personal computers, laptop computers and handheld computers. Valuation requests may be generated from manual and/or scanned entries. A request may include vehicle identifiers such as vehicle year, make, model, trim (i.e., series and body style), mileage, options, and condition, as well as one or more location identifiers such as a region, state, city or zip code of the country. In response to valuation requests, the system searches the transaction database for a matching record and returns the resulting wholesale, retail, purchase, and reconditioning values to a user either via a web application, web service or mobile PDA application.

In one aspect of an exemplary implementation of the invention, a method for determining a value of a specified used vehicle according to specified conditions is provided. The method entails providing a database of used vehicle valuation data from a plurality of actual transactions by a plurality of industry participants. The used vehicle valuation data includes vehicle configuration data, condition data, purchase data, sales data, reconditioning data, days in inventory, and geographical data. Average purchase data is determined from the database for the specified used vehicle according to the specified conditions. Then the average purchase data for the specified used vehicle is provided to an end user.

In another aspect of an exemplary implementation of the invention, the method for determining a value of a specified used vehicle according to specified conditions may further entail determining from the database average sales data for the specified used vehicle according to the specified conditions and providing the average sales data for the specified used vehicle to an end user.

In another aspect of an exemplary implementation of the invention, the method for determining a value of a specified used vehicle according to specified conditions may further entail determining from the database average reconditioning data for the specified used vehicle according to the specified conditions and providing the average reconditioning data for the specified used vehicle to an end user.

In another aspect of an exemplary implementation of the invention, the step of providing a database of used vehicle valuation data from a plurality of transactions by a plurality of industry participants may entail receiving used vehicle valuation data from a plurality of actual transactions by a plurality of industry participants, and storing the used vehicle valuation data in the database. The step of providing a database of used vehicle valuation data from a plurality of transactions by a plurality of industry participants may further entail validating the used vehicle valuation data received from a plurality of actual transactions by a plurality of industry participants, and storing validated used vehicle valuation data in the database. Validation may include a vehicle identification number validity check and/or a variance check.

In another aspect of an exemplary implementation of the invention, the method for determining a value of a specified used vehicle according to specified conditions may further entail receiving a valuation request from an end user, wherein the valuation request includes vehicle identification data and corresponding geographic data. The vehicle identification data may include a vehicle year, a vehicle make, a vehicle model, a vehicle trim (i.e., series and body style), a vehicle mileage, a vehicle color, and a vehicle condition. A vehicle identification number may additionally or alternatively be provided. The vehicle identification number may be obtained by scanning a barcode corresponding to a vehicle identification number or by manual entry.

In another aspect of an exemplary implementation of the invention, used vehicle valuation data in the database may include a vehicle year, a vehicle make, a vehicle model, a vehicle color, a vehicle engine type, a vehicle identification number, a vehicle mileage, a vehicle purchase price, a vehicle stock date, a vehicle purchase zip code, a vehicle purchase city, vehicle reconditioning or repair costs, vehicle sold date, vehicle sale price, and vehicle sale type. Purchase data may include data for the nation, a region, a state, or zip code area. Purchase data may be comprised of an average purchase price, average reconditioning cost, average adjustment, and average total cost equal to the average purchase price+average reconditioning cost+average adjustment.

In another aspect of an exemplary implementation of the invention, retail sales data may include average retail sale price, average reconditioning costs, average purchase price, average retail gross amount equal to average retail sale price+trade-in value−average purchase price−average reconditioning costs, average adjustment, and average days in inventory.

In another aspect of an exemplary implementation of the invention, wholesale sales data may include average wholesale sale price, average reconditioning costs, average purchase price, average wholesale gross amount equal to average wholesale sale price−average purchase price−average reconditioning costs average adjustment, and average days in inventory.

In another aspect of an exemplary implementation of the invention, a system for determining a value of a specified used vehicle according to specified conditions is provided. The system includes a network accessible valuation application having a user input interface configured for receiving information about the specified used vehicle and specified conditions. A database of used vehicle data is also provided as part of the system. The used vehicle data is obtained from a plurality of actual transactions by a plurality of industry participants. The used vehicle data may include vehicle configuration data, condition data, purchase data, sales data, reconditioning data, days in inventory, and geographical data. The database is operably coupled to the valuation application. A module (e.g., web application and/or database management system) is also provided as part of the system to determine from the database average vehicle data for the specified used vehicle according to the specified conditions. Optionally, the database is operably coupled to a plurality of dealership vehicle management systems and configured to periodically receive used vehicle data from the dealership vehicle management systems for a plurality of transactions by a plurality of dealerships.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high-level block diagram of an exemplary networked computer system according to principles of the invention;

FIG. 2 provides a high-level block diagram of components of an exemplary networked computer system configured for submission of dealer transaction data to a server according to principles of the invention;

FIG. 3 provides a high-level block diagram of components of an exemplary networked computer system configured for communication of valuation data from a server to computing devices including hand held computers according to principles of the invention;

FIG. 4 provides a high-level flowchart of an exemplary process of submitting dealer transaction data to a server according to principles of the invention;

FIG. 5 provides another high-level flowchart of an exemplary process of submitting dealer transaction data to a server according to principles of the invention;

FIG. 6 provides a high-level flowchart of an exemplary process of requesting valuation data for a used vehicle according to principles of the invention;

FIG. 7 provides another high-level flowchart of an exemplary process of requesting valuation data for a used vehicle according to principles of the invention;

FIG. 8 conceptually illustrates a portion of a user interface for requesting valuation data for a used vehicle according to principles of the invention;

FIG. 9 conceptually illustrates a portion of a user interface for displaying valuation data for a used vehicle according to principles of the invention;

FIG. 10 conceptually illustrates a portion of a user interface for displaying valuation data for a used vehicle on a handheld computer according to principles of the invention;

FIG. 11 conceptually illustrates another portion of user interface for displaying valuation data for a used vehicle on a handheld computer according to principles of the invention;

FIG. 12 conceptually illustrates another portion of a user interface for displaying valuation data for a used vehicle on a handheld computer according to principles of the invention; and

FIG. 13 conceptually illustrates a portion of a user interface for requesting valuation data for a used vehicle from a handheld computer according to principles of the invention;

FIG. 14 conceptually illustrates another portion of a user interface for requesting valuation data for a used vehicle from a handheld computer according to principles of the invention;

FIG. 15 conceptually illustrates another portion of a user interface for requesting valuation data for a used vehicle from a handheld computer according to principles of the invention; and

FIG. 16 conceptually illustrates another portion of a user interface for requesting valuation data for a used vehicle from a handheld computer according to principles of the invention.

Those skilled in the art will appreciate that the invention is not limited to the exemplary embodiments depicted in the figures, or the components, steps, interrelationships, configurations, or order of steps shown in the figures.

### DETAILED DESCRIPTION

The invention is directed to an interactive used vehicle valuation system and method, and in particular a system and method adapted for providing vehicle valuation data based upon actual transaction data for selected regions. The valuation data includes wholesale pricing data, repair data, days in inventory and retail pricing data, all of which is determined from actual transaction data and all of which is associated with geographical regions. The system is adapted to receive transaction data, either automatically from a dealer management system or upon dealer submission, via online communication. The received data populates a database, which is used for determining valuation data for a user-specified vehicle and geographic area. The system is adapted to receive and process valuation requests from client computers, which may include remote computing devices such as personal computers, laptop computers and handheld computers. Valuation requests may be generated from manual and/or scanned entries. In response to valuation requests, the system returns corresponding vehicle valuation data to the requesting client computers.

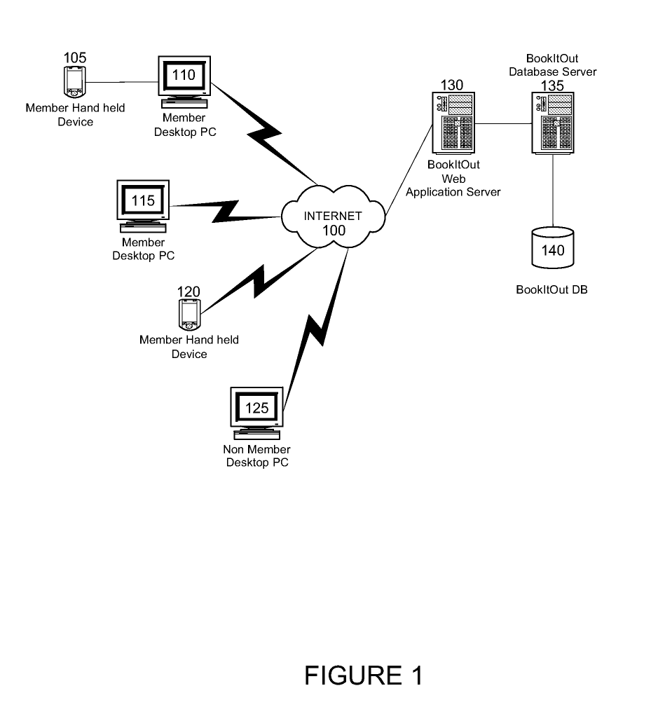

With reference to the drawings, wherein like numerals represent like features, FIG. 1 provides a high-level block diagram of an exemplary networked computer system according to principles of the invention. A database server 135 hosts a database management system for managing a transaction database 140, including steps of writing and reading data to and from the database 140. The database 140 is communicatively coupled to the database server 135, and may reside on the database server 135 or on a separate computer and/or one or more separate database storage devices. A web application server 130, which is communicatively coupled to the database server 135, hosts information, documents, scripts and software needed to provide user interfaces and enable performance of methodologies in accordance with an exemplary embodiment of the invention. By way of example and not limitation, the web application server 130 may include web page information, documents and scripts (e.g., HTML and XML code), applets and application software, which enable users to submit valuation requests and display valuation data in response to valuation requests from users.

A plurality of users (e.g., used auto dealerships, finance companies, insurance companies, banks, auctions, and warranty companies) may access the web application server 130 using compatible computing devices 105-125 with network connectivity. By way of example, such devices 105-125 may include personal computers, laptop computers, handheld computers a/k/a personal digital assistants, kiosks, mobile phones or any compatibly equipped electronic computing devices. User computing systems may include an operating system and a browser or similar application software configured to properly process and display information, documents, software, applications, applets and scripts provided by the web application server 130. Although five user computing devices 105-125 are shown for illustrative purposes, any number of user computers may be used in accordance with the invention.

The invention is not limited to any particular network connectivity or communication protocol. Various forms of communication networks may be used by the user computers 105-125 to access the web application server. By way of example and not limitation, a proprietary Wide Area Network (WAN) or a public WAN, such as the Internet 100, may be used. These networks typically employ various protocols such as the HyperText Transfer Protocol (HTTP), File Transfer Protocol (FTP), Extensible Markup Language (XML), and Transfer Control Protocol/Internet Protocol (TCP/IP) to facilitate communication of information between communicatively coupled computers. A system according to the present invention may also utilize wireless networks, including those utilizing Global System for Mobile (GSM), Code Division Multiple Access (CDMA) or Time Division Multiple Access technology, and the Wireless Application Protocol (WAP). Furthermore, a system according to the invention may utilize any, all, and any combination of such communications networks, as well as communications networks hereafter developed.

The computing devices described herein (e.g., personal computers, handheld computers [e.g., PDAs] and servers) may be comprised of commercially available computers, hardware and operating systems. The aforementioned computing devices are intended to represent a broad category of computer systems capable of functioning in accordance with the present invention. Of course, the computing devices may include various components, peripherals and software applications provided they are compatible and capable of performing functions in accordance with the present invention. The computing devices also include information, documents, data and files needed to provide functionality and enable performance of methodologies in accordance with an exemplary embodiment of the invention.

A firewall may be located between FTP server 215 and the database server 135, as well as between the web server 130 and database server 135, to protect against corruption, loss, or misuse of data. The firewall limits access by the FTP server 215 and web server 130 and prevents corruption of POS data. Thus, the FTP server 215 and web server 130 may be configured to update and receive data only to the extent necessary. The firewalls may be comprised of any hardware and/or software suitably configured to provide limited or restricted access to the database server 135. The firewalls may be integrated within the database server 135 or another system component, or may reside as a standalone component.

Functions and process steps described herein may be performed using programmed computer devices and related hardware, peripherals, equipment and networks. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

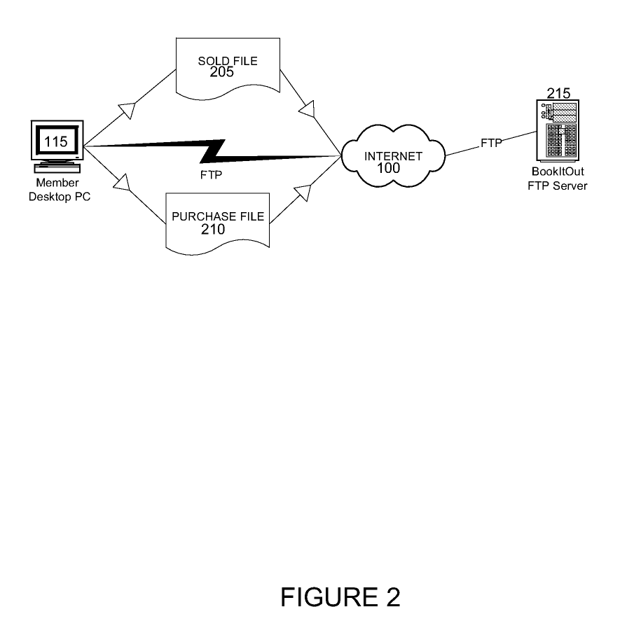

Referring now to FIG. 2, a high-level block diagram of architecture components of an exemplary networked computer system configured for submission of dealer transaction data to a server according to principles of the invention is conceptually shown. The FTP server 215, running FTP server software, listens on the network for connection requests from other computers. FTP or File Transfer Protocol is a commonly used protocol for exchanging files over any network that supports the TCP/IP protocol (such as the Internet or an intranet). The same computer may be configured to function as the web application server and FTP server, or separate computers may be utilized for these servers. In an exemplary implementation, the user's computer 115 running FTP client software, initiates a connection to the FTP server 215. Before file transfer begins, the end user's computer 115 and server 215 may negotiate a port of the data connection. Once connected, the user's computer 115 can upload files to the server 215 and download files from the server.

Transaction data files from industry participants, such as from used auto dealerships, finance companies, insurance companies, banks, auctions, and/or warranty companies, are uploaded to the FTP server periodically. The files may be uploaded automatically, or upon user command. The transaction data files may include data corresponding to vehicles sold by the user 205, as well as data corresponding to vehicles purchased by the user 210. The transaction data files may be comprised of one integrated file or a plurality of separate files or other data structures. In addition to purchase and/or sales data, the transaction data preferably is date stamped and includes vehicle identifiers such as vehicle identification number (VIN), year, make, model, trim (i.e., series and body style), mileage, options, and condition data; as well as one or more location identifiers such as a region, state, city and zip code data, for each purchase and sales transaction reported to the server. Purchase transaction data also preferably includes purchase price and stock date, while sales transaction data preferably includes reconditioning (i.e., reconditioning/repair) costs, sales price and a sales identifier to distinguish wholesale and retail sales. Upon validation of uploaded files, the FTP server directly or indirectly communicates the files and/or transaction data to the database server 135 for updating the database 140.

The FTP client software may be a module integrated with a dealership management system or a separate application. Illustratively, an add-on or plug-in module may be provided to interface with a dealership management system. The module or application may be configured to periodically copy transaction data from the dealership into a transaction file and send the transaction file to the FTP server 215. The copying and transmission may be programmed to occur at user-selected times and frequencies, or upon user command.

Important aspects of an exemplary implementation of the invention are the use of actual transaction data and association of the data with geographical identifiers. Instead of relying upon conventional guidebook data or a manipulated variation thereof, a system according to principles of the invention facilitates gathering actual transaction data and enables computing valuations based thereon. Because actual transaction data is used, a more detailed and precise valuation is achieved. The valuation may include actual wholesale prices, actual reconditioning data, actual days in inventory and actual retail prices, all of which may be associated with geographical regions. Illustratively, using the system, a user may readily determine the current average wholesale price for a particular vehicle within a specified geographic region, state, city, or zip code. The user may also assess whether a vehicle is in demand in the dealer's territory as evidenced by days in inventory, how much work and parts are typically required to recondition/repair such a vehicle for resale, and the average retail price for such a vehicle.

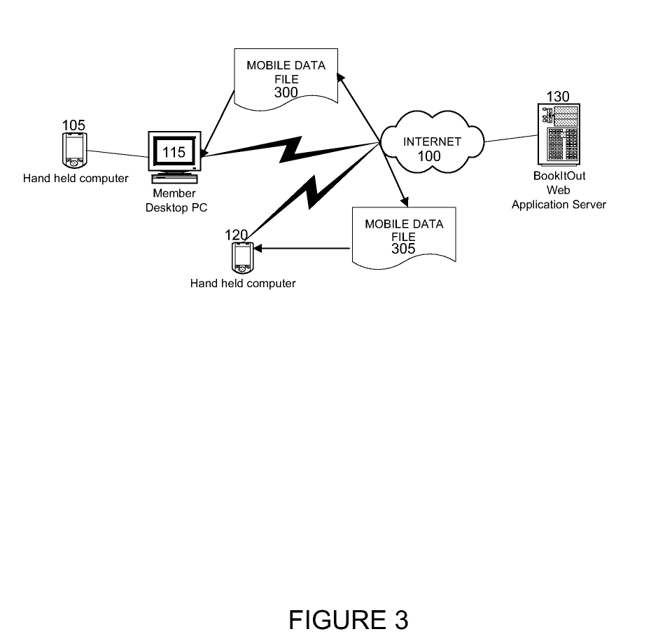

Referring now to FIG. 3, a high-level block diagram of components of an exemplary networked computer system configured for communication of valuation data from a server to handheld computing devices according to principles of the invention is conceptually shown. The system is adapted to receive and process valuation requests from client computers 105-120, such as handheld computers 105, 120. Valuation requests may be generated from manual and/or scanned entries. A request may include vehicle identifiers such as vehicle year, make, model, trim (i.e., series and body style), mileage, options, and condition, as well as one or more location identifiers such as a region, state, city or zip code of the country. For example, a user may request valuation data for a 1996 Volvo 960, 4-Door Sedan, in good condition, with 100,000 miles, in Jacksonville, Fla. Valuation requests are received by the web application server 130, where they are processed into queries for the database server 135. In response to valuation requests and corresponding queries, the database server 135 searches the transaction database 140 for a matching record and returns the resulting wholesale, retail, purchase, and reconditioning values to a user either via a web application or mobile PDA application. The returned values are averages of actual transaction data in the database 140.

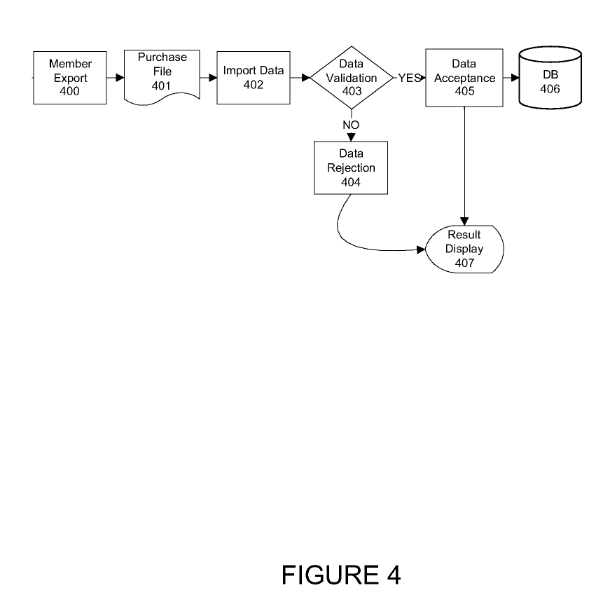

Referring now to FIG. 4, a high-level flowchart of an exemplary process of submitting dealer transaction data for purchased vehicles to a server according to principles of the invention is provided. In step 400, purchase transaction data is exported from a dealer inventory management system used to inventory used vehicle purchases. Upon export, a compatibly formatted (e.g., comma delimited text) file containing vehicle purchase information is produced. Illustratively, an exemplary file may include the following fields of data:
Vehicle Year
Vehicle Make
Vehicle Model
Vehicle Color
Vehicle Engine Type
Vehicle Model Type
Vehicle Identification Number (VIN)
Vehicle Mileage
Vehicle Purchase Price
Vehicle Stock Date
Vehicle Purchase Zip Code
Vehicle Purchase City
Vehicle Reconditioning or Repair Costs

Next, the properly formatted file is imported into the transaction database 406. Importing entails validating the data as in step 403. Data that fails validation is rejected and not inserted into the database, in accordance with step 404. A failure report may be provided to the user explaining that the data was rejected and providing a reason in step 407. Data that passes validation is accepted and inserted into the database, in accordance with step 405. A success report may be sent to the user indicating that the data was accepted, as in step 407.

A multi-stage validation is preferred. One stage of validation entails checking the validity of the vehicle information using the supplied VIN. A conventional VIN is comprised of seventeen (17) characters that do not include the letters I, O or Q. The first three characters uniquely identify the manufacturer of the vehicle. The 4th through 9th positions in the VIN identify the vehicle type, and may include information on the platform used, the model, and the body style. Position 9 is a check digit. The 10th through 17th positions identify the individual vehicle in question, including the year as well as information on options installed or engine and transmission choices. Specifically, position 10 encodes the model year of the vehicle and position 111 encodes the factory of manufacture of the vehicle. If the VIN is invalid or does not match the entered vehicle characteristics, the data fails validation. Thus, this aspect of validation helps ensure a high level of integrity of data within the transaction database 406.

Another stage of validation entails comparing used vehicle purchase information with similar purchases in the transaction database that antedate the purchase being validated. A variance greater than a determined amount suggests the data is of questionable validity or the product of an atypical transaction. In such cases, the imported data may be rejected as in step 404. This aspect of validation also helps ensure a high level of data integrity within the transaction database 406.

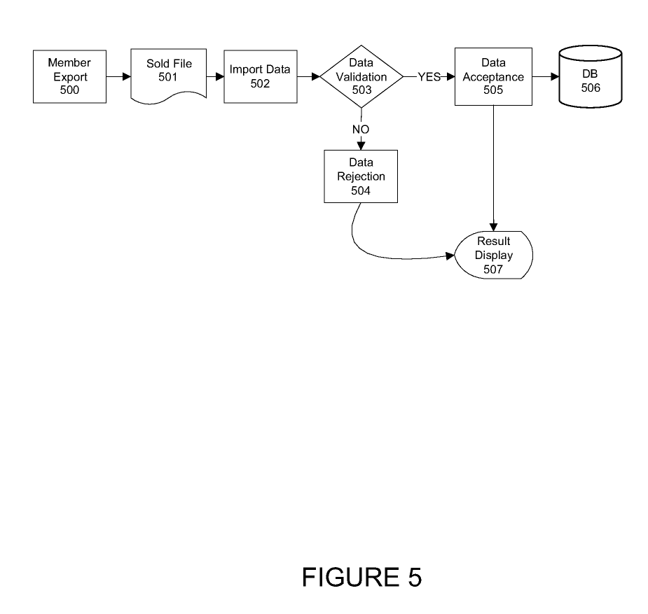

Referring now to FIG. 5, a high-level flowchart of an exemplary process of submitting dealer transaction data for sold vehicles to a server according to principles of the invention is provided. In step 500, purchase transaction data is exported from a dealer inventory management system used to inventory used vehicle purchases. Upon export, a compatibly formatted (e.g., comma delimited text) file containing vehicle purchase information is produced. Illustratively, an exemplary file may include the following fields of data:
Vehicle Year
Vehicle Make
Vehicle Model
Vehicle Color
Vehicle Engine Type
Vehicle Model Type
Vehicle Identification Number (VIN)
Vehicle Mileage
Vehicle Purchase Price
Vehicle Stock Date
Vehicle Purchase Zip Code
Vehicle Purchase City
Vehicle Reconditioning or Repair Costs
Vehicle Sold Date
Vehicle Sale Price
Vehicle Sale Type (Wholesale or Retail)

Next, the properly formatted file is imported into the transaction database 506. Importing entails validating the data as in step 503. Data that fails validation is rejected and not inserted into the database, in accordance with step 504. A failure report may be provided to the user explaining that the data was rejected and providing a reason in step 507. Data that passes validation is accepted and inserted into the database, in accordance with step 505. A success report may be sent to the user indicating that the data was accepted, as in step 507.

As with importing purchase data, a multi-stage validation is preferred for importing sold vehicle data. One stage of validation entails checking the validity of the vehicle information using the supplied VIN. A conventional VIN is comprised of seventeen (17) characters that do not include the letters I, O or Q. The first three characters uniquely identify the manufacturer of the vehicle. The 4th through 9th positions in the VIN identify the vehicle type, and may include information on the platform used, the model, and the body style. Position 9 is a check digit. The 10th through 17th positions identify the individual vehicle in question, including the year as well as information on options installed or engine and transmission choices. Specifically, position 10 encodes the model year of the vehicle and position 111 encodes the factory of manufacture of the vehicle. If the VIN is invalid or does not match the entered vehicle characteristics, the data fails validation. Thus, this aspect of validation helps ensure a high level of integrity of data within the transaction database 506.

Advantageously, in one embodiment of the invention, a compatible handheld computing device includes a user interface for interacting with a user and/or a barcode or other-type scanner for logging and identifying a vehicle. The user interface may be optionally arranged with a manual data entry device (e.g., a keyboard, keypad, pointing device and/or touch sensitive screen), a display and rich graphical-user-interface (GUI) environment to provide display of vehicle data and other information, user-friendly access to features, and streamlined data entry. As a vehicle identification number provides information about the vehicle make, model, year and other features, the exemplary system may be configured to allow a user to enter a vehicle identification number in lieu of entering such parameters (i.e., make, model, year) separately. Additionally, the vehicle identification number may be entered manually or by scanning a barcode corresponding to the vehicle identification number using a barcode scanner device coupled to the handheld computing device. Modern vehicles typically include a scannable barcode representation of the vehicle identification number at one or more locations on the vehicle. Thus, the compatible handheld computing device may include a barcode scanning module, such as an infrared or laser barcode scanner, configured to facilitate quick and accurate entry of Vehicle Identification Numbers (VINs) from vehicles equipped with bar coded VINs.

Another stage of validation entails comparing used vehicle purchase information with similar purchases in the transaction database that antedate the purchase being validated. A variance greater than a determined amount suggests the data is of questionable validity or the product of an atypical transaction. In such cases, the imported data may be rejected as in step 504. This aspect of validation also helps ensure a high level of data integrity within the transaction database 506.

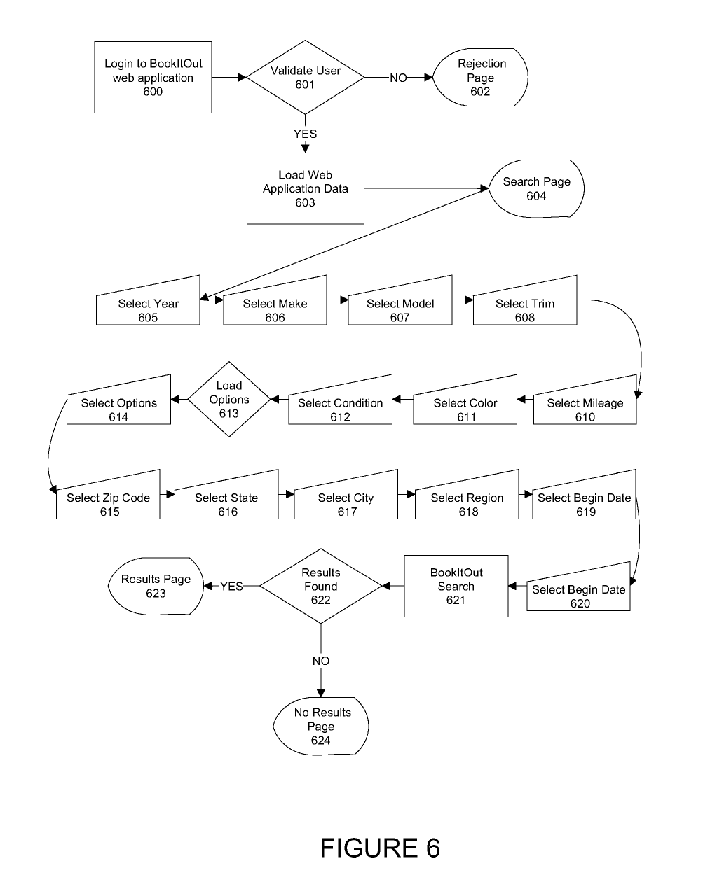

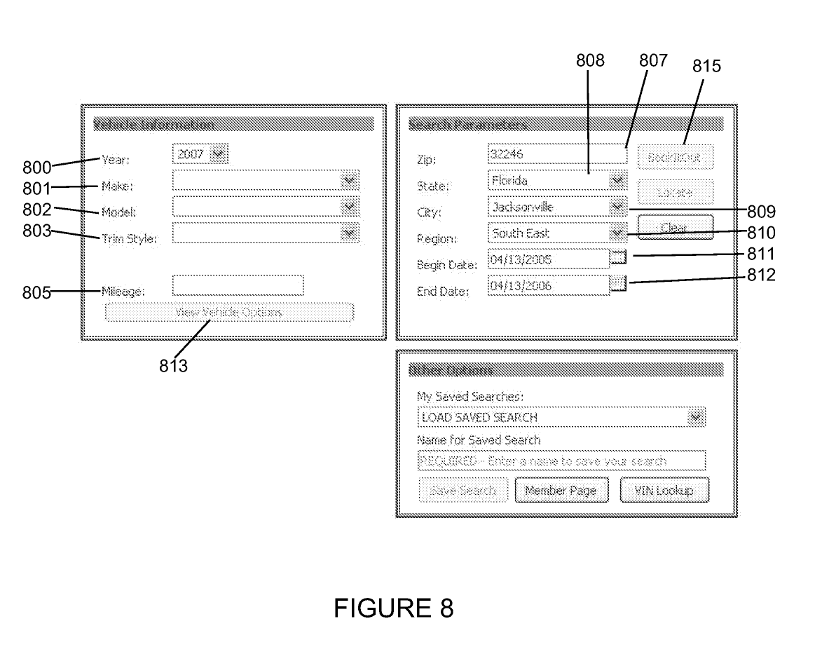

A high-level flowchart of an exemplary process of requesting valuation data for a used vehicle from a web application according to principles of the invention is provided in FIG. 6. First, a user logs into a web application as in step 600. Next, the application validates the user's credentials, as in step 601. If a user's credentials are rejected, the user is notified, as in step 602. However, if a user's credentials are accepted, the application loads application data and user specific settings, as in step 603, and displays a search page (as shown in FIG. 8), as in step 604. On the search page, the user selects or inputs the following:
A vehicle year (800 in FIG. 8), as in step 605.
A vehicle make (801 in FIG. 8), as in step 606.
A vehicle model (802 in FIG. 8), as in step 607.
A vehicle trim (i.e., series and body style) (803 in FIG. 8), as in step 608.
Vehicle mileage (805 in FIG. 8), as in step 610.
A vehicle color, as in step 611.
A vehicle condition, as in step 612.

Next, in step 613, vehicle options are loaded from a database based upon the vehicle specified by the user in steps 605, 606, 607, 608, 609, 610, 611, and 612. The user selects vehicle options (813 in FIG. 8) in step 614. The user also selects or inputs geographical information to search for a selected vehicle. Illustratively, the user selects a zip code (807 in FIG. 8), as in step 615; a state (808 in FIG. 8), as in step 616; a city (809 in FIG. 8), as in step 617; a region (810 in FIG. 8), as in step 618.

Subsequently, date parameters are entered. The user selects a begin search date for the selected vehicle (811 in FIG. 8), as in step 619. The user also selects an end search date for the selected vehicle (812 in FIG. 8), as in step 620. Transaction data in the database within the specified date range is utilized. To proceed, a BookItOut button 815 is selected.

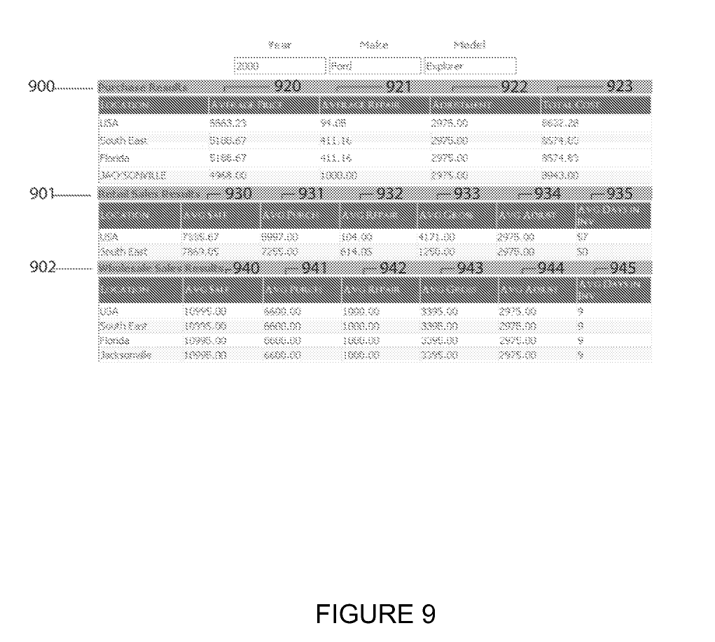

Next the database is searched, as in step 621. If no results are found based upon the user input, a no results page is displayed, as in step 624. If results are available, the vehicle according to the user selections and pricing information for the vehicle within the date range are found, as in step 622, in the transaction database for the following geographical regions:
National used vehicle pricing (FIG. 9)
Regional used vehicle pricing (FIG. 9)
State used vehicle pricing (FIG. 9)
Zip Code used vehicle pricing (FIG. 9)
City used vehicle pricing (FIG. 9)

The results are then displayed to the user (as shown in FIG. 9) in accordance with step 623. The following information is returned to the user for the vehicle and geographic selections:
Purchase Results (900 in FIG. 9)
   Average Purchase Price (920 in FIG. 9)
   Average Repair/Reconditioning Amount (921 in FIG. 9)
   Average Adjustment based upon mileage, condition, and options supplied by the user (922 in FIG. 9)
   Average Total Cost (923 in FIG. 9) which is the (Purchase Price+Reconditioning Costs in FIG. 9)+Adjustments
Retail Sales Results (901 in FIG. 9)
   Average Sale Price (930 in FIG. 9)
   Average Purchase Price (931 in FIG. 9)
   Average Repair/Reconditioning Amount (932 in FIG. 9)
   Average Gross Amount (933 in FIG. 9) which is Sale Price+Trade-In Value−Purchase Price−Reconditioning Costs
   Average Adjustment based upon mileage, condition, and options supplied by the user (934 in FIG. 9)
   Average Days in Inventory (935 in FIG. 9)—which is the difference between Stock Date and Sold Date
Wholesale Sales Results (902 in FIG. 9)
   Average Sale Price (940 in FIG. 9)
   Average Purchase Price (941 in FIG. 9)
   Average Repair/Reconditioning Amount (942 in FIG. 9)
   Average Gross Amount (943 in FIG. 9) which is Sale Price+Trade-In Value−Purchase Price−Reconditioning Costs
   Average Adjustment based upon mileage, condition, and options supplied by the user (944 in FIG. 9)
   Average Days in Inventory (945 in FIG. 9)—which is the difference between Stock Date and Sold Date

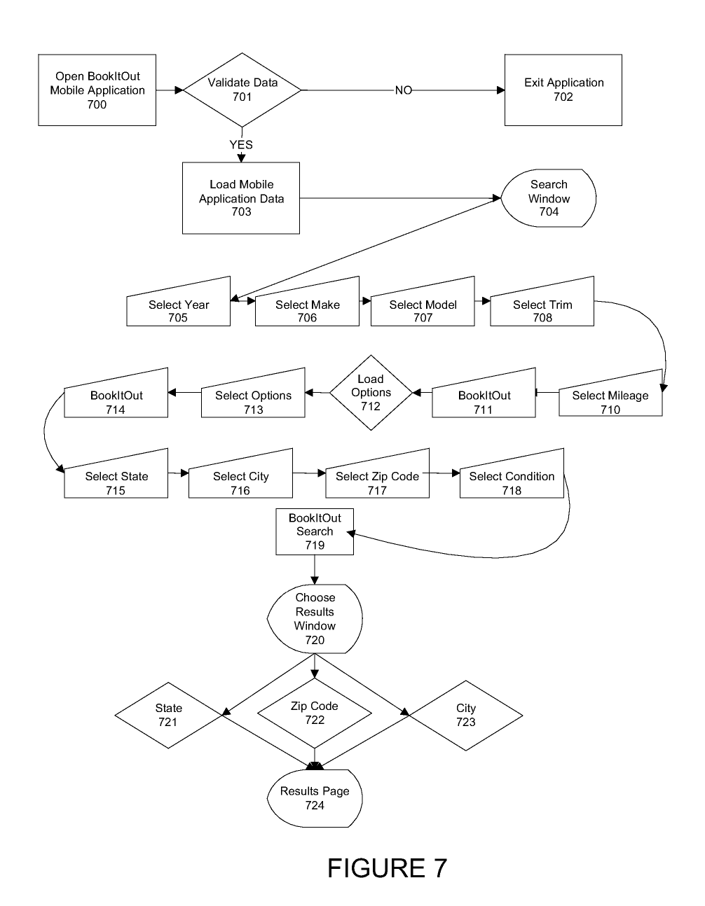

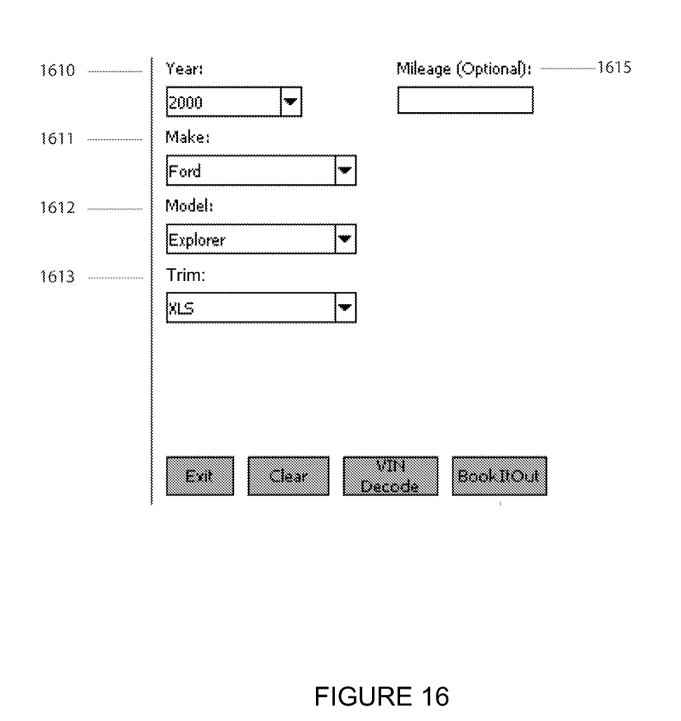

Referring now to FIG. 7, a high-level flowchart of an exemplary process of requesting valuation data for a used vehicle from a handheld computer according to principles of the invention is shown. First, a user logs into a mobile application as in step 700. Next, the application validates the user's credentials, as in step 701. If a user's credentials are rejected, the user is notified and the application is exited, as in step 702. However, if a user's credentials are accepted, the application loads application data and user specific settings, as in step 703, and displays a search page (as shown in FIG. 16), as in step 704. On the search page, the user selects or inputs the following:
A vehicle year (1610 in FIG. 16), as in step 705.
A vehicle make (1611 in FIG. 16), as in step 706.
A vehicle model (1612 in FIG. 16), as in step 707.
A vehicle trim (i.e., series and body style) (1613 in FIG. 16), as in step 708.
Vehicle mileage (1615 in FIG. 16), as in step 710.

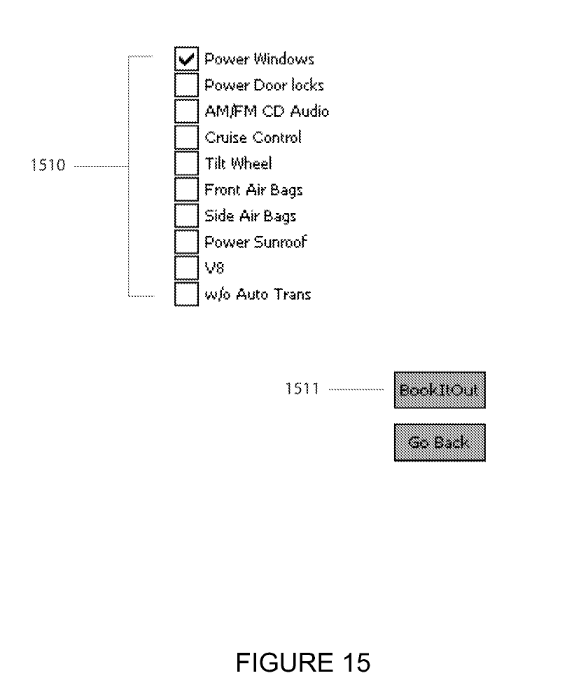

Next, in step 711, a user may select a BookItOut button to proceed. In step 712, vehicle options are loaded from a database based upon the vehicle specified by the user in steps 705, 706, 707, 708, 709, 710. The user selects vehicle options (1510 in FIG. 15) and selects a BookItOut button 1511 to proceed, in step 713.

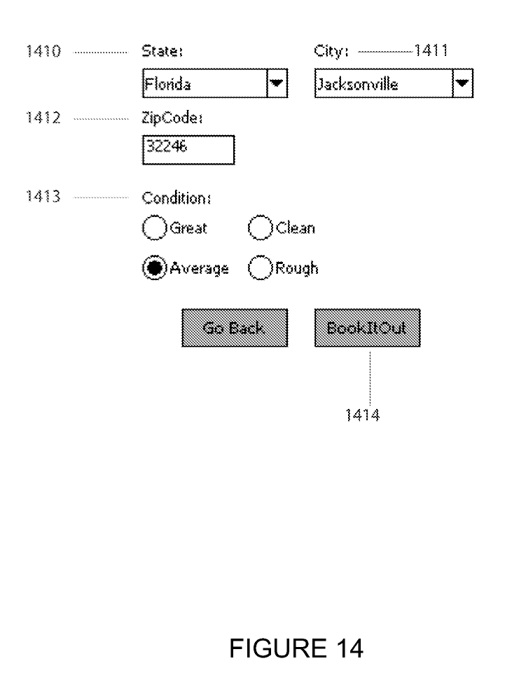

After selecting options, the user selects a button to proceed to the next form, as in step 714, where the user will select or input geographical information to search for a selected vehicle. Illustratively, the user selects a state (1410 in FIG. 14), as in step 715; a city (1411 in FIG. 14), as in step 716; a zip code (1412 in FIG. 14), as in step 717.

After specifying location (i.e., geographical) information, the user specifies the vehicle condition (1413 in FIG. 14), as in step 718. Selecting a BookItOut button (1414 in FIG. 14) allows the user to proceed.

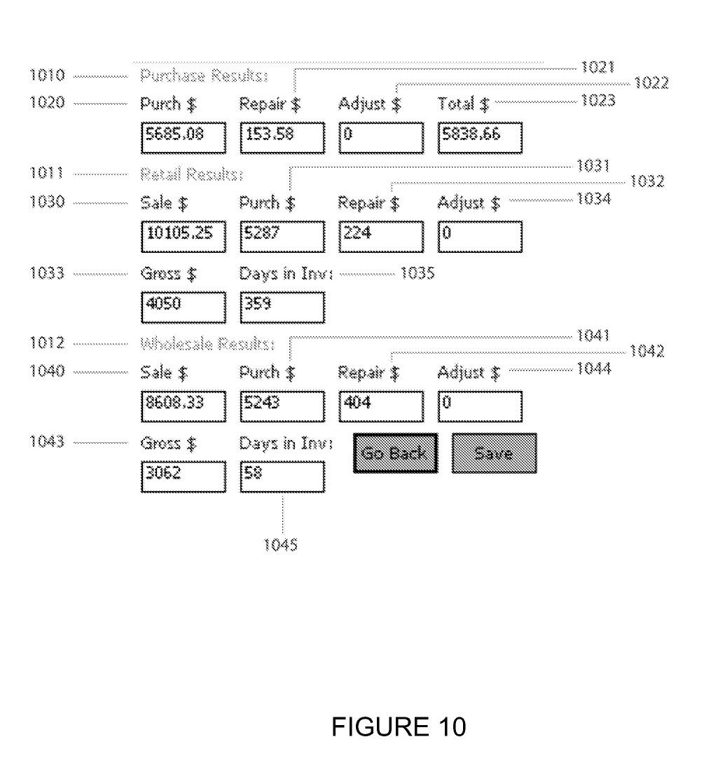

Next the database is searched, as in step 719. If results are available, the vehicle according to the user selections and pricing information for the vehicle are found, as in step 719, in the transaction database for the following geographical regions:
State used vehicle pricing (FIG. 10)
Zip Code used vehicle pricing (FIG. 10)
City used vehicle pricing (FIG. 10)

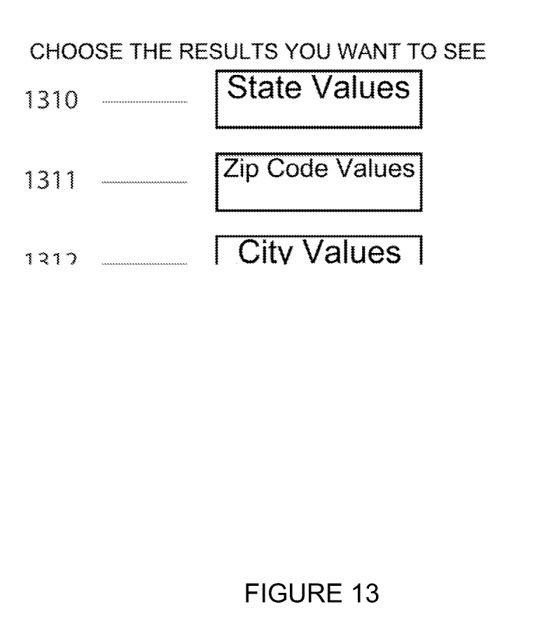

The results are then made available for display to the user (as shown in FIG. 13) in accordance with step 720, which allows the user to select from available displays, such as a state 1310, zip code 1311 or city 1312 display. In accordance with step 721, the following information is returned to the user for the vehicle and state 1310 selection:
Purchase Results (1010 in FIG. 10)
   Average Purchase Price (1020 in FIG. 10)
   Average Repair/Reconditioning Amount (1021 in FIG. 10)
   Average Adjustment based upon mileage, condition, and options supplied by the user (1022 in FIG. 10)
   Average Total Cost (1023 in FIG. 10) which is the (Purchase Price+Reconditioning Costs)+Adjustments
Retail Sales Results (1011 in FIG. 10)
   Average Sale Price (1030 in FIG. 10)
   Average Purchase Price (1031 in FIG. 10)
   Average Repair/Reconditioning Amount (1032 in FIG. 10)
   Average Gross Amount (1033 in FIG. 10) which is Sale Price+Trade-In Value−Purchase Price−Reconditioning Costs
   Average Adjustment based upon mileage, condition, and options supplied by the user (1034 in FIG. 10)
   Average Days in Inventory (1035 in FIG. 10)—which is the difference between Stock Date and Sold Date
Wholesale Sales Results (1012 in FIG. 10)
   Average Sale Price (1040 in FIG. 10)
   Average Purchase Price (1041 in FIG. 10)
   Average Repair/Reconditioning Amount (1042 in FIG. 10)
   Average Gross Amount (1043 in FIG. 10) which is Sale Price+Trade-In Value−Purchase Price−Reconditioning Costs
   Average Adjustment based upon mileage, condition, and options supplied by the user (1044 in FIG. 10)
   Average Days in Inventory (1045 in FIG. 10)—which is the difference between Stock Date and Sold Date.

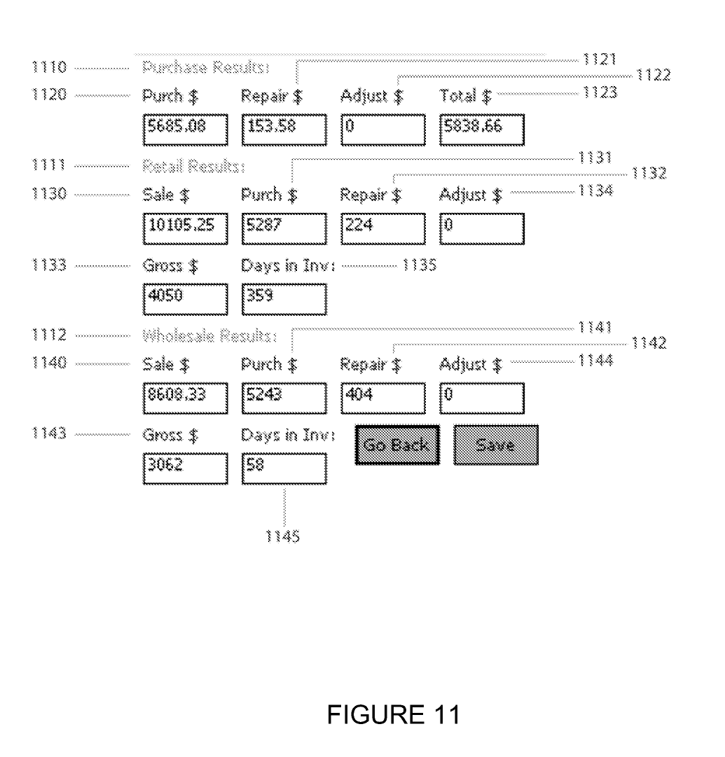

In accordance with step 722, the following information is returned to the user for the vehicle and zip code 1311 selection:
Purchase Results (1110 in FIG. 11)
   Average Purchase Price (1120 in FIG. 11)
   Average Repair/Reconditioning Amount (1121 in FIG. 11)
   Average Adjustment based upon mileage, condition, and options supplied by the user (1122 in FIG. 11)
   Average Total Cost (1123 in FIG. 11) which is the (Purchase Price+Reconditioning Costs)+Adjustments
Retail Sales Results (1111 in FIG. 11)
   Average Sale Price (1130 in FIG. 11)
   Average Purchase Price (1131 in FIG. 11)
   Average Repair/Reconditioning Amount (1132 in FIG. 11)
   Average Gross Amount (1133 in FIG. 11) which is Sale Price−Purchase Price−Reconditioning Costs
   Average Adjustment based upon mileage, condition, and options supplied by the user (1134 in FIG. 11)
   Average Days in Inventory (1135 in FIG. 11)—which is the difference between Stock Date and Sold Date
Wholesale Sales Results (1112 in FIG. 11)
   Average Sale Price (1140 in FIG. 11)
   Average Purchase Price (1141 in FIG. 11)
   Average Repair/Reconditioning Amount (1142 in FIG. 11)
   Average Gross Amount (1143 in FIG. 11) which is Sale Price+Trade-In Value−Purchase Price−Reconditioning Costs
   Average Adjustment based upon mileage, condition, and options supplied by the user (1144 in FIG. 11)
   Average Days in Inventory (1145 in FIG. 11)—which is the difference between Stock Date and Sold Date

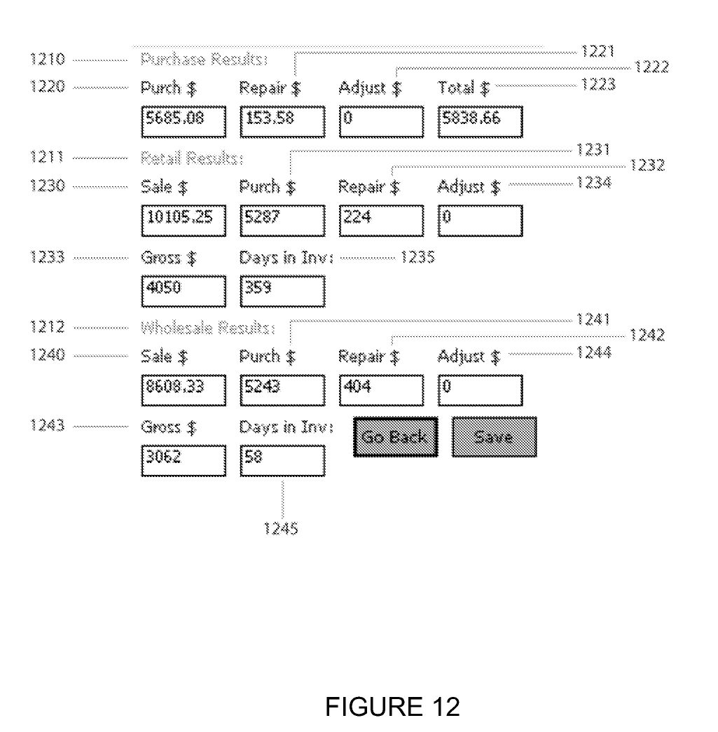

In accordance with step 721, the following information is returned to the user for the vehicle and city 1312 selection:
Purchase Results (1210 in FIG. 12)
   Average Purchase Price (1220 in FIG. 12)
   Average Repair/Reconditioning Amount (1221 in FIG. 12)
   Average Adjustment based upon mileage, condition, and options supplied by the user (1222 in FIG. 12)
   Average Total Cost (1223 in FIG. 12) which is the (Purchase Price+Reconditioning Costs)+Adjustments
Retail Sales Results (1211 in FIG. 12)
   Average Sale Price (1230 in FIG. 12)
   Average Purchase Price (1231 in FIG. 12)
   Average Repair/Reconditioning Amount (1232 in FIG. 12)
   Average Gross Amount (1233 in FIG. 12) which is Sale Price+Trade-In Value−Purchase Price−Reconditioning Costs
   Average Adjustment based upon mileage, condition, and options supplied by the user (1234 in FIG. 12)
   Average Days in Inventory (1235 in FIG. 12)—which is the difference between Stock Date and Sold Date
Wholesale Sales Results (1212 in FIG. 12)
   Average Sale Price (1240 in FIG. 12)
   Average Purchase Price (1241 in FIG. 12)
   Average Repair/Reconditioning Amount (1242 in FIG. 12)
   Average Gross Amount (1243 in FIG. 12) which is Sale Price+Trade-In Value−Purchase Price−Reconditioning Costs
   Average Adjustment based upon mileage, condition, and options supplied by the user (1244 in FIG. 12)
   Average Days in Inventory (1245 in FIG. 12)—which is the difference between Stock Date and Sold Date

Then, a results page is displayed using the above data and in accordance with user input and selections, as in step 724.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of an exemplary embodiment and illustrative of the principles of the invention. As numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method for determining a value of a specified used vehicle according to specified conditions, said method comprising:
Providing a database of used vehicle valuation data from a plurality of actual transactions by a plurality of industry participants, said used vehicle valuation data including vehicle configuration data, condition data, purchase data, sales data, reconditioning data, days in inventory, and geographical data;
Determining from said database average purchase data for the specified used vehicle according to the specified conditions; and
Providing said average purchase data for the specified used vehicle to an end user.

2. A method for determining a value of a specified used vehicle according to specified conditions according to claim 1, said method further comprising
Determining from said database average sales data for the specified used vehicle according to the specified conditions; and
Providing said average sales data for the specified used vehicle to an end user.

3. A method for determining a value of a specified used vehicle according to specified conditions according to claim 1, said method further comprising
Determining from said database average reconditioning data for the specified used vehicle according to the specified conditions; and
Providing said average reconditioning data for the specified used vehicle to an end user.

4. A method for determining a value of a specified used vehicle according to specified conditions according to claim 1, wherein the step of providing a database of used vehicle valuation data from a plurality of transactions by a plurality of industry participants, includes steps of receiving used vehicle valuation data from a plurality of actual transactions by a plurality of industry participants, and storing said used vehicle valuation data in the database.

5. A method for determining a value of a specified used vehicle according to specified conditions according to claim 1, wherein the step of providing a database of used vehicle valuation data from a plurality of transactions by a plurality of industry participants, includes steps of receiving used vehicle valuation data from a plurality of actual transactions by a plurality of industry participants, validating said used vehicle valuation data received from a plurality of actual transactions by a plurality of industry participants, and storing validated used vehicle valuation data in the database.

6. A method for determining a value of a specified used vehicle according to specified conditions according to claim 1, wherein the step of providing a database of used vehicle valuation data from a plurality of transactions by a plurality of industry participants, includes steps of receiving used vehicle valuation data from a plurality of actual transactions by a plurality of industry participants, validating said used vehicle valuation data received from a plurality of actual transactions by a plurality of industry participants, and storing validated used vehicle valuation data in the database; said step of validating said used vehicle valuation data received from a plurality of actual transactions including performing a vehicle identification number validity check.

7. A method for determining a value of a specified used vehicle according to specified conditions according to claim 1, wherein the step of providing a database of used vehicle valuation data from a plurality of transactions by a plurality of industry participants, includes steps of receiving used vehicle valuation data from a plurality of actual transactions by a plurality of industry participants, validating said used vehicle valuation data received from a plurality of actual transactions by a plurality of industry participants, and storing validated used vehicle valuation data in the database; said step of validating said used vehicle valuation data received from a plurality of actual transactions including performing a variance check.

8. A method for determining a value of a specified used vehicle according to specified conditions according to claim 1, said method further comprising Receiving a valuation request from an end user, said valuation request including vehicle identification data.

9. A method for determining a value of a specified used vehicle according to specified conditions according to claim 1, said method further comprising Receiving a valuation request from an end user, said valuation request including vehicle identification data and corresponding geographic data.

10. A method for determining a value of a specified used vehicle according to specified conditions according to claim 1, said method further comprising
Receiving a valuation request from an end user, said valuation request including vehicle identification data and corresponding geographic data, said vehicle identification data including:
a vehicle year;
a vehicle make;
a vehicle model;
a vehicle trim;
vehicle mileage;
a vehicle color; and
a vehicle condition.

11. A method for determining a value of a specified used vehicle according to specified conditions according to claim 1, said method further comprising
Receiving a valuation request from an end user, said valuation request including a vehicle identification number and corresponding geographic data.

12. A method for determining a value of a specified used vehicle according to specified conditions according to claim 1, said method further comprising
Receiving a valuation request from an end user, said valuation request including a vehicle identification number and corresponding geographic data, said vehicle identification number being obtained by scanning a barcode corresponding to a vehicle identification number.

13. A method for determining a value of a specified used vehicle according to specified conditions according to claim 1, said used vehicle valuation data including for each of a plurality of vehicles a vehicle year;
a vehicle make;
a vehicle model;
a vehicle color;
a vehicle engine type;
a vehicle identification number;
a vehicle mileage;
a vehicle purchase price;
a vehicle stock date;
a vehicle purchase zip code; and
a vehicle purchase city.

14. A method for determining a value of a specified used vehicle according to specified conditions according to claim 1, said used vehicle valuation data including for each of a plurality of vehicles a vehicle year;
a vehicle make;
a vehicle model;
a vehicle color;
a vehicle engine type;
a vehicle identification number;
a vehicle mileage;
a vehicle purchase price;
a vehicle stock date;
a vehicle purchase zip code;
a vehicle purchase city;
vehicle reconditioning or repair costs;
vehicle sold date;
vehicle sale price; and
vehicle sale type.

15. A method for determining a value of a specified used vehicle according to specified conditions according to claim 1, wherein the step of determining from said database average purchase data for the specified used vehicle according to the specified conditions includes determining purchase data from the group consisting of:
national used vehicle valuation data;
regional used vehicle valuation data;
state used vehicle valuation data;
zip code used vehicle valuation data; and
city used vehicle valuation data.

16. A method for determining a value of a specified used vehicle according to specified conditions according to claim 1, wherein the step of determining from said database average purchase data for the specified used vehicle according to the specified conditions includes determining purchase data from the group consisting of:
average purchase price;
average reconditioning cost;
average adjustment; and
average total cost equal to the average purchase price+average reconditioning cost+average adjustment.

17. A method for determining a value of a specified used vehicle according to specified conditions according to claim 2, wherein the average sales data includes retail sales data from the group consisting of:
average retail sale price;
average reconditioning costs;
average purchase price;
average retail gross amount equal to average retail sale price+trade-in value−average purchase price−average reconditioning costs
average adjustment; and
average days in inventory.

18. A method for determining a value of a specified used vehicle according to specified conditions according to claim 2, wherein the average sales data includes wholesale sales data from the group consisting of:
average wholesale sale price;
average reconditioning costs;
average purchase price;
average wholesale gross amount equal to average wholesale sale price−average purchase price−average reconditioning costs
average adjustment; and
average days in inventory.

19. A system for determining a value of a specified used vehicle according to specified conditions, said system comprising:
A network accessible valuation application having a user input interface configured for receiving information about the specified used vehicle and specified conditions;
A database of used vehicle data obtained from a plurality of actual transactions by a plurality of industry participants, said used vehicle data including vehicle configuration data, condition data, purchase data, sales data, reconditioning data, days in inventory, and geographical data, said database being operably coupled to the valuation application; and
A module configured to determine from said database average vehicle data for the specified used vehicle according to the specified conditions.

20. A system for determining a value of a specified used vehicle according to specified conditions according to claim 19, wherein the database of used vehicle data is operably coupled to a plurality of dealership vehicle management systems and configured to periodically receive used vehicle data from the dealership vehicle management systems for a plurality of transactions by a plurality of dealerships.
